(19) United States
(12) Patent Application Publication
(10) Pub. No.: US 2022/0403084 A1
(43) Pub. Date: Dec. 22, 2022

(54) PROCESS FOR PREPARATION OF MONODISPERSE PARTICLES

(71) Applicant: N-lab Technology Center Pte. Ltd., Singapore (SG)

(72) Inventors: He-Kuan Luo, Singapore (SG); Honglei Wang, Singapore (SG); Kelei Chen, Singapore (SG)

(73) Assignee: N-lab Technology Center Pte. Ltd., Singapore (SG)

(21) Appl. No.: 17/755,694

(22) PCT Filed: Nov. 2, 2020
(86) PCT No.: PCT/SG2020/050625

§ 371 Date: May 5, 2022

Related U.S. Application Data
(60) Provisional application No. 62/930,663, filed on Nov. 5, 2019.

(51) Int. Cl. C08F 257/02

(52) U.S. Cl. CPC C08F 257/02

(57) ABSTRACT

Disclosed here are polymer particles comprising a plurality of polymeric stabilizing components, each polymeric stabilizing component comprising one or more hydrophilic polymer chains; and a plurality of hydrophobic polymer chains, each hydrophobic polymer chain covalently bonded to one or more of the polymeric stabilizing components, wherein the polymer particles are monodisperse and have a coefficient of variation based on their diameter of less than 20%. Also disclosed herein is a method of generating polymer particles.

### FIELD OF INVENTION

This invention relates to highly monodisperse polymer particles useful in biological assays and other applications. It also relates to processes for preparing highly monodisperse submicron particles, specifically diameter ranging between 100-370 nm.

### BACKGROUND

The listing or discussion of a prior-published document in this specification should not necessarily be taken as an acknowledgement that the document is part of the state of the art or is common general knowledge.

In recent years, immunological procedures have been increasingly featured in clinical diagnostic methods because of their high specificity and sensitivity. Latex agglutination is one of the heterogeneous immunological assay methods that is widely used in biology and medicine for detecting small quantities of an antibody or antigen in a fluid test sample. The agglutination reaction involves in vitro aggregation of microscopic carrier particles (usually of a polymeric nature, referred to as latex particles). This aggregation is mediated by the specific reaction between antibodies and antigens, where either the antibody or antigen is immobilised or adsorbed on the surface of the latex particles. Given this, the sensitivity and reproducibility of such assays are highly dependent on the consistency of particle surface area. This is in turn dependent on the monodispersity and size repeatability of the latex particles, which have to be consistent between production batches. For immunodiagnostic applications, the diameter of the particles is required to be about half of the visible light wavelength, which is around 100 nm to 370 nm, and the monodispersity (in terms of coefficient of variation) is preferably below 5%.

Emulsion polymerisation is defined as “polymerisation whereby monomer(s), initiator, dispersion medium, and possibly colloid stabilizer constitute initially an inhomogeneous system resulting in particles of colloidal dimensions containing the formed polymer” (Pure Appl. Chem., 2011, 83, 2229-2259). In the process the components are mixed and homogenised. After a stable emulsion is achieved, the initiator is activated and polymerisation starts. The stability of the emulsion is a critical factor for achieving monodisperse polymer beads. Surfactants or emulsifiers are conventionally used to form a stable emulsion system, and the type of monomers and surfactants control the formation of micelles, which in turn control the size and distribution of the obtained polystyrene beads. In US20170218095A1 which describes polystyrene seeds synthesis via an emulsion polymerisation method, sodium dodecyl sulfate (SDS) was used as a surfactant, ammonium persulfate (APS) as initiator and borax to increase ionic strength. Styrene was extracted with 10 wt % sodium hydroxide to remove stabilizer (4-tert-butylcatechol) which can inhibit the polymerization of styrene, and thus affects the polymerization rate, the diameter of the polystyrene beads diameter and monodispersity. The resulting monodisperse polystyrene particles have a size ranging from 50 to 200 nm.

A specific emulsion polymerisation method discovered by John Ugelstad, also known as the seed-activated method (U.S. Pat. No. 4,530,956; WO 00/61647), has been used to prepare monodisperse seeds having a size of from 50 to 200 nm. However, the method involves tedious steps (more than one polymerisation cycle) and complicated recipes. Briefly, the process involves contacting seeds with a mixture of reagents containing organic solvent to swell the seeds. The excess organic solvent is then removed and a surfactant, a monomer, an initiator and a cross-linker are added to form an activated seed particle in an aqueous vehicle. The monomer, initiator and cross-linker diffuse into the activated seed particles to form an aqueous dispersion of swollen seed particles, which initiates the polymerisation of the monomer and cross-linker in the swollen seed particles.

Dispersion polymerisation is defined as “precipitation polymerisation in which monomer(s), initiator(s), and colloid stabilizer(s) are dissolved in a solvent forming initially a homogeneous system that produces polymer and results in the formation of polymer particles” (Pure Appl. Chem., 2011, 83, 2229-2259). The formation of an initial homogenous system is critical in producing monodisperse polymer beads. Oil-soluble initiators, such as benzoyl peroxide (BPO) [Can. J. Chem. 1985, 63, 209-216], azobisisobutyronitrile (AIBN)/2,2′-Azodi(2-methylbutyronitrile) (AMBN) [J. Polym. Sci.: Part A: 1986, 24, 2995-3007; J. Polym. Sci.: Part A: 1996, 4, 1857-1871] and ammonium persulfate (APS) [Macromolecular Research, 2010, 8, 935-943] are commonly used in dispersion polymerisations. Sodium persulfate (SPS) and potassium persulfate (KPS), which are water soluble but oil-insoluble, have not been reported to be used as initiators in homogeneous dispersion polymerisation of styrene.

In order to obtain monodisperse polystyrene beads via dispersion polymerisation, binary solvent systems are conventionally used. For example, with BPO as initiator, a mixture of ethanol (175 mL) and 2-methoxyethanol (250 mL) was used as a binary solvent system which was able to produce monodisperse polystyrene beads having a diameter of 3 μm, with hydroxypropylcellulose (HPC) being used as a steric stabilizer [Can. J. Chem. 1985, 63, 209-216]. In principle, dispersion polymerisation requires that all the components (monomer, initiator, and stabilizer) to be fully soluble in the initial solvent system to form a homogeneous solution. Therefore, water alone cannot be used as a solvent because styrene is not soluble in water. Instead, a mixture of alcohol and water (such as 85% of ethanol and 15% of water) is commonly used (Can. J. Chem. 1985, 63, 209-216; J. Polym. Sci.: Part A: Polymer Chemistry, 1987, 25, 1395-1407). In another size control study (Macromolecular Research, 2010, 18, 935-943), monodisperse polystyrene beads were prepared using polyvinylpyrrolidone (PVP) as steric stabilizer, ammonium persulfate (APS) as initiator, and aqueous ethanol (ethanol/water in a 25/3 volume ratio) as solvent. This study also showed that when a pure aqueous media (only water as solvent) was used, there was a loss of control in the particle size, shape and size distribution, and thus it was concluded that monodisperse polystyrene beads could not be produced by dispersion polymerisation in water alone. It is worth noting that it is not possible to produce particles of a lower size using dispersion polymerisation as the resulting particles were all found to be above 1 μm.

Surfactant-free emulsion polymerisation involves three components in the system: a monomer, water and an initiator. The initiator is typically chosen from 2,2′-azobis(2-methylpropionamidine) dihydrochloride (AIBA), potassium persulfate (KPS) and ammonium persulfate (APS), which are soluble in water. The process of polymerising styrene involves mixing water and styrene monomers to form an emulsion system at specific reaction conditions, and subsequently adding an initiator-water solution to initiate the reaction.
In Langmuir 2004, 20, 4400-4405, it was found that the mechanism for forming polystyrene beads involves mainly precipitation and nucleation of polystyrene in water. The number of polystyrene beads formed from styrene micelles is very small and can be neglected. It was also demonstrated that the size of the particles was controlled by reaction time and temperature, and the use of AIBA did not result in monodisperse polystyrene particles.
In another study (Colloid Polym. Sci. 1999, 277, 607-626), the use of AIBA and KPS were compared. It was found that the KPS recipe resulted in bigger particle sizes with a higher standard deviation than that of AIBA recipe, but the particles from both recipes were below 200 nm. Other recipes with different ionic strengths also did not result in monodisperse polystyrene particles having a particle size above 200 nm.
In Eur. Polym. J., 1994, 30, 179-183, it was demonstrated that increasing the amount of APS could generate larger particle sizes at the cost of a broader particle size distribution. It was further believed that the smallest monodisperse polystyrene bead achievable with APS without adding any co-monomer is 250 nm.

The use of KPS in surfactant-free emulsion polymerisation of styrene has been studied for more than 20 years. Interestingly and surprisingly, sodium persulfate (SPS), which is cheaper than KPS and APS, has not been reported to be used as an initiator in surfactant-free emulsion polymerisation of styrene. Even though SPS, KPS and APS are all commonly used persulfate initiators, their influence on the monodispersity of polystyrene particles is not obvious. This is because of the differences in their solubility, ionic strength, size of cations, viscosity and decomposition temperature. Therefore, it will be useful to develop a new surfactant-free emulsion polymerisation technology using SPS as cheap initiator, to produce monodisperse polystyrene colloidal solution that bears Na⁺.

Surfactant-free emulsion polymerisation of styrene is typically initiated with a styrene-saturated solution. This is because the procedure involves adding a water-initiator solution to a mixture of styrene and water. The use of a styrene-saturated solution may account for the formation of anomalous regions on beads that are believed to be caused by the uneven monomer distribution within the polystyrene particles [Colloid Polym. Sci. 1999, 277, 607-626].

In summary, it is evident that existing polymerisation methods are not able to provide highly monodisperse polystyrene particles that are suitable for immunodiagnostic applications. The size of the particles produced is either too small (up to 200 nm) or too big (above 1 μm). In addition, the particle size and/or monodispersity are affected by the choice of surfactants (for surfactant-mediated emulsion polymerisation), choice of initiator and initiator concentrations (for surfactant-free emulsion polymerisation) and polarity of solvent (for dispersion polymerisation). There is therefore a need for an improved process for preparing monodisperse submicron particles that are suitable for clinical diagnostic methods. It is noted that monodisperse submicron particles have many applications in micro- and nano-fluidics and nanotechnology in general.

### SUMMARY OF INVENTION

Aspects and embodiments of the current invention will now be described by reference to the following numbered clauses.

1. Polymer particles comprising:
a plurality of polymeric stabilizing components, each polymeric stabilizing component comprising one or more hydrophilic polymer chains; and
a plurality of hydrophobic polymer chains, each hydrophobic polymer chain covalently bonded to one or more of the polymeric stabilizing components, wherein:
the polymer particles are monodisperse and have a coefficient of variation based on their diameter of less than 20%.

2. The polymer particles according to Clause 1, wherein the particles have a coefficient of variation based on their diameter of less than 15%, such as less than 10%, such as less than 5%.

3. The polymer particles according to Clause 2, wherein the particles have a coefficient of variation based on their diameter of less than or equal to 2%.

4. The polymer particles according to Clause 3, wherein the particles have a coefficient of variation based on their diameter of less than or equal to 1%.

5. The polymer particles according to any one of the preceding clauses, wherein the polymer particles have an average diameter of from 50 to 1000 nm, such as from 100 to 600 nm, such as from 120 to 450 nm, such as from 150 to 400 nm, such as from 200 to 350 nm.

6. The polymer particles according to any one of the preceding clauses, wherein the hydrophilic polymer chains of the polymeric stabilizing components are selected from the group consisting of poly(vinylpyrrolidone), polyethylenimine, polyacrylic acid, polyvinyl alcohol, water soluble polysaccharides (e.g. hydroxypropyl methylcellulose, chitosan, and blends thereof), copolymers thereof and blends thereof.

7. The polymer particles according to Clause 6, wherein the hydrophilic polymer chains of the polymeric stabilizing components are poly(vinylpyrrolidone).

8. The polymer particles according to any one of the preceding clauses, wherein the hydrophobic polymer chains are formed from monomers selected from one or more of styrene and derivatives thereof, acrylates, and alkylacrylates.

9. The polymer particles according to Clause 8, wherein the hydrophobic polymer chains are formed from monomers selected from one or more of styrene, butyl acrylate, 2,2,2-trifluoro ethyl methacrylate, methyl methacrylate, 4-methylstyrene, 3-methylstyrene, and 4-tertbutylstyrene.

10. The polymer particles according to Clause 9, wherein the hydrophobic polymer chains are formed from styrene.

11. The polymer particles according to any one of the preceding clauses, wherein the weight:weight ratio of the plurality of polymeric stabilizing components to the plurality hydrophobic polymer chains is from 1:1000 to 1:1, such as from 1:500 to 1:2, such as from 1:300 to 1:3, such as from 1:150 to 1:5.

12. The polymer particles according to any one of the preceding clauses, wherein the hydrophobic polymer chains are formed as copolymers and/or are crosslinked.

13. The polymer particles according to Clause 12, wherein:

(a) when the hydrophobic polymer chains are copolymers, they are formed from a first set of monomers that is hydrophobic selected from one or more of styrene and derivatives thereof, acrylates, and alkylacrylates; and
a second set of monomers selected from one or more of monomers having a carboxylic acid group, a monomer having hydroxyl group, a monomer having an amino group, and a monomer having an epoxy group; and/or

(b) when the hydrophobic polymer chains are crosslinked, the crosslinked polymer chains are formed by a crosslinking agent that reacts with the first and/or, when present, second set of monomers, optionally wherein the crosslinking agent is a monomer having two or more unsaturated groups.

14. The polymer particles according to Clause 13, wherein:

(ai) the first set of monomers is selected from one or more of styrene, butyl acrylate, 2,2,2-trifluoro ethyl methacrylate, methyl methacrylate, 4-methylstyrene, 3-methylstyrene, and 4-tertbutylstyrene; and/or

(bi) the second set of monomers is selected from one or more of acrylic acid, methacrylic acid, 2-carboxyethyl acrylate, acrylamide, methacrylamide, allylamine, (hydroxyethyl)methacrylate, hydroxypropyl methacrylate, 4-hydroxybutyl acrylate, glycidyl methacrylate, allyl glycidyl ether, 1,2-epoxy-5-hexene, 1,4-diamino-6-diallylamino-1,3,5-triazine, diallylamine, and triallylamine; and/or

(ci) the crosslinking agent is selected from one or more of divinylbenzene, ethylene glycol dimethylacrylate, bisphenol A dimethacrylate, butanediol dimethacrylate, tricyclodecane dimethanol diacrylate, pentaerythritol triacrylate, tripropylene glycol diacrylate, propoxylated neopentyl diacrylate, pentaerythritol triacrylate, ditrimethylolpropane tetraacrylate, dipentaerythritol pentaacrylate, dipentaerythritol penta/hexa-acrylate, tripropylene diacrylate, trimethylol propane ethoxylate triacrylate, trimethylol propane propoxylate triacrylate, di(trimethylolpropane) tetraacrylate, glycerol propoxylate triacrylate, pentaerythritol propoxylate triacrylate, poly(ethylene glycol) diacrylate, poly(propylene glycol) diacrylate, and tri(propylene glycol) diacrylate.

15. The polymer particles according to Clause 14, wherein:

(aii) the first set of monomers is styrene; and/or

(bii) the second set of monomers is selected from one or more of N,N′-methylenebis(acrylamide), 1,4-Diamino-6-diallylamino-1,3,5-triazine, diallylamine, and triallylamine; and/or

(cii) the crosslinking agent is selected from one or more of divinylbenzene, ethylene glycol dimethylacrylate, bisphenol A dimethacrylate.

16. The polymer particles according to any one of Clauses 13 to 15, wherein:

(aiii) when present, the weight:weight ratio of the first set of monomers to the second set of monomers is from 40:1 to 1:1, such as from 20:1 to 2:1; and/or

(biii) when present, the weight:weight ratio of the first set of monomers to the crosslinking agent is from 40:1 to 1:1, such as from 20:1 to 2:1.

17. The polymer particles according to any one of the preceding clauses, wherein the particles are functionalised with a sulfate salt with the formula —SO₄⁻M⁺, where the dash represents the point of attachment to the polymer particles and M⁺ represents Na⁺, K⁺ or NH₄⁺.

18. A method of generating polymer particles, the method comprising:

(A) reacting a hydrophilic polymeric stabilizer compound with a water-soluble initiator compound in water to form a macroinitiator complex in an aqueous solution;

(B) forming a biphasic polymerisation reaction mixture by adding one or more water-immiscible monomers to the macroinitiator complex in an aqueous solution, and allowing the reaction to run for a first period of time until particle nucleation occurs; and

(C) either allowing the reaction to continue for a second period of time or quenching the reaction after the first period of time to provide the polymer particles, wherein the polymer particles are monodisperse and have a coefficient of variation based on their diameter of less than 20%.

19. The process according to Clause 18, wherein the particles have a coefficient of variation based on their diameter of less than 15%, such as less than 10%, such as less than 5%.

20. The process according to Clause 19, wherein the particles have a coefficient of variation based on their diameter of less than or equal to 2%.

21. The process according to Clause 20, wherein the particles have a coefficient of variation based on their diameter of less than or equal to 1%.

22. The process according to any one or Clauses 18 to 21, wherein the polymer particles have an average diameter of from 50 to 1000 nm, such as from 100 to 600 nm, such as from 120 to 450 nm, such as from 150 to 400 nm, such as from 200 to 350 nm.

23. The process according to any one of Clauses 18 to 22, wherein the water-soluble initiator comprises one or more of a peroxide initiator, a persulfate salt and an azo initiator.

24. The process according to Clause 23, wherein the water-soluble initiator is selected from one or more of tertiary-amyl hydroperoxide, potassium persulfate, sodium persulfate, ammonia persulfate, 4,4′-azobis(4-cyanovaleric acid), 2,2′-azobis[2-methyl-N-(2-hydroxyethyl)propionamide, 2,2′-azobis[N-(2-carboxyethyl)-2-methylpropionamidine]hydrate, 2,2′-azobis(2-methylpropionamidine) dihydrochloride, 2,2″-azobis[2-(2-imidazolin-2-yl)propane], and 2,2′-azobis[2-(2-imidazolin-2-yl)propane] dihydrochloride.

25. The process according to Clause 24, wherein the water-soluble initiator is selected from one or more of potassium persulfate, sodium persulfate, and ammonia persulfate.

26. The process according to Clause 25, wherein the water-soluble initiator is sodium persulfate.

27. The process according to Clause 23, wherein the water-soluble initiator is a redox pair, optionally wherein the redox pair is selected from ascorbic acid and hydrogen peroxide or ammonia persulfate and sodium bisulfite.

28. The process according to any one of Clauses 18 to 27, wherein the hydrophilic polymeric stabilizer compound is selected from the group consisting of poly(vinylpyrrolidone), polyethylenimine, polyacrylic acid, polyvinyl alcohol, water soluble polysaccharides (e.g. hydroxypropyl methylcellulose, chitosan, and blends thereof), copolymers thereof and blends thereof.

29. The process according to Clause 28, wherein the hydrophilic polymeric stabilizer compound is poly(vinylpyrrolidone).

30. The process according to Clause 28, wherein the hydrophilic polymeric stabilizer compound is a water soluble polysaccharide, such as hydroxypropyl methylcellulose.

31. The process according to any one of Clauses 18 to 30 wherein the one or more water-immiscible monomers are selected from one or more of styrene and derivatives thereof, acrylates, and alkylacrylates.

32. The process according to Clause 31, wherein the one or more water-immiscible monomers are selected from one or more of styrene, butyl acrylate, 2,2,2-trifluoro ethyl methacrylate, methyl methacrylate, 4-methylstyrene, 3-methylstyrene, and 4-tertbutylstyrene.

33. The process according to Clause 32, wherein the one or more water-immiscible monomers are styrene.

34. The process according to any one of Clauses 18 to 33, wherein the weight:weight ratio of the hydrophilic polymeric stabilizer compound to the water-immiscible monomers is from 1:1000 to 1:1, such as from 1:500 to 1:2, such as from 1:300 to 1:3, such as from 1:150 to 1:5.

35. The process according to any one of Clauses 18 to 34, wherein in step (c) the reaction is continued for a second period of time.

36. The process according to Clause 35, wherein when the reaction is continued for a second period of time, a second set of monomers and/or or a crosslinking agent is added to the reaction mixture,
which second set of monomers is selected from one or more of a monomer having a carboxylic acid group, a monomer having hydroxyl group, a monomer having an amino group, and a monomer having an epoxy group,
which crosslinking agent is a monomer having two or more unsaturated groups.

37. The process according to Clause 36, wherein:

(ia) the second set of monomers is selected from one or more of acrylic acid, methacrylic acid, 2-carboxyethyl acrylate, acrylamide, methacrylamide, allylamine, (hydroxyethyl)methacrylate, hydroxypropyl methacrylate, 4-hydroxybutyl acrylate, glycidyl methacrylate, allyl glycidyl ether, 1,2-epoxy-5-hexene, 1,4-diamino-6-diallylamino-1,3,5-triazine, diallylamine, and triallylamine; and/or

(ib) the crosslinking agent is selected from one or more of divinylbenzene, ethylene glycol dimethylacrylate, bisphenol A dimethacrylate, butanediol dimethacrylate, tricyclodecane dimethanol diacrylate, pentaerythritol triacrylate, tripropylene glycol diacrylate, propoxylated neopentyl diacrylate, pentaerythritol triacrylate, ditrimethylolpropane tetraacrylate, dipentaerythritol pentaacrylate, dipentaerythritol penta/hexa-acrylate, tripropylene diacrylate, trimethylol propane ethoxylate triacrylate, trimethylol propane propoxylate triacrylate, di(trimethylolpropane) tetraacrylate, glycerol propoxylate triacrylate, pentaerythritol propoxylate triacrylate, poly(ethylene glycol) diacrylate, poly(propylene glycol) diacrylate, and tri(propylene glycol) diacrylate.

38. The process according to Clause 37, wherein:

(iia) the second set of monomers is selected from one or more of N,N′-methylenebis(acrylamide), 1,4-Diamino-6-diallylamino-1,3,5-triazine, diallylamine, and triallylamine; and/or

(iib) the crosslinking agent is selected from one or more of divinylbenzene, ethylene glycol dimethylacrylate, bisphenol A dimethacrylate.

39. The process according to any one of Clauses 36 to 38, wherein:

(iiia) when present, the weight:weight ratio of the first set of monomers to the second set of monomers is from 40:1 to 1:1, such as from 20:1 to 2:1; and/or

(iiib) when present, the weight:weight ratio of the first set of monomers to the crosslinking agent is from 40:1 to 1:1, such as from 20:1 to 2:1.

40. The process according to any one of Clauses 18 to 39, wherein the molar ratio of the water-soluble initiator compound to the hydrophilic polymeric stabilizer compound is from 10:1 to 10,000:1, such as from 20:1 to 5,000:1, such as from 30:1 to 1000:1, such as from 50:1 to 500:1.

41. The process according to any one of Clauses 18 to 40, wherein the concentration of the hydrophilic polymeric stabilizer compound in the aqueous solution is from 0.01% to 20 wt %, such as from 0.05% to 10 wt %, such as from 0.1% to 5.0 wt %.

42. The process according to any one of Clauses 18 to 40, wherein the process is substantively free of surfactants and organic solvents.

### DRAWINGS

Certain embodiments of the present disclosure are described more fully hereinafter with reference to the accompanying drawings.

FIG. 1 depicts a proposed mechanism of “monomer-deficient polymerisation initiation and nucleation using pre-formed macroradical via H-abstraction”.

FIG. 2 depicts a schematic representation of macroradicals formed from polyvinylpyrrolidone (PVP), polyacrylic acid (PAA) and chitosan after H-abstraction.

FIG. 3 depicts the SEM image of polystyrene beads in sample 1.

FIG. 4 depicts the SEM image of polystyrene beads in sample 2.

FIG. 5 depicts the SEM image of polystyrene beads in sample 3.

FIG. 6 depicts the SEM image of polystyrene beads in sample 4.

FIG. 7 depicts the SEM image of polystyrene beads in sample 5.

FIG. 8 depicts the SEM image of polystyrene beads in sample 1 after incubation with THF.

FIG. 9 depicts the SEM image of polystyrene beads in sample 5 after incubation with THF.

FIG. 10 depicts the SEM image of polystyrene beads in sample 6.

FIG. 11 depicts the SEM images of polystyrene beads in sample 7 showing A) polydispersity of the beads and B) an anomalous region on a bead.

### DESCRIPTION

The current invention solves one or more of the problems identified above.

It has been surprisingly found that it is possible to manufacture monodisperse polymer particles that can be used in an array of applications. These monodisperse polymer particles have a surprising degree of monodispersity and, as mentioned above, can be used in a wide range of applications, making them highly desirable. For example, the monodisperse polymer particles may be suitable for clinical diagnostic methods (e.g. immunodiagnostic applications), as well as for use in applications related to micro- and nano-fluidics and nanotechnology in general.

Thus, in a first aspect of the invention, there is provided polymer particles comprising:
a plurality of polymeric stabilizing components, each polymeric stabilizing component comprising one or more hydrophilic polymer chains; and
a plurality of hydrophobic polymer chains, each hydrophobic polymer chain covalently bonded to one or more of the polymeric stabilizing components, wherein:
the polymer particles are monodisperse and have a coefficient of variation based on their diameter of less than 20%.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

When used herein, the term “monodisperse” refers to particles having a low coefficient of variation (CV) of a specific parameter (e.g. particle diameter), for example a CV of less than 20%, such as less than 15%, such as less than 10%, such as less than 5%. More particularly, the particles may have a CV of less than or equal to 2%, such as less than or equal to 1%. The term “monodisperse” also encompasses the term “highly monodisperse”, which when used herein refers to a CV of less than 5%, such as less than or equal to 2%, such as less than or equal to 1%.

When used herein, the term “coefficient of variation” refers to its statistical meaning. That is:

$$C V ( \% ) = \frac{s t a ndard deviation}{m e a n} \times 100$$

The terms “standard deviation” and “mean” take their ordinary statistical meanings.

As discussed hereinbelow, the diameters of the polymer particles may be measured by imaging techniques, such as SEM images.

The polymer particles disclosed herein may have any suitable average diameter. For example, the polymer particles may have an average diameter of from 50 to 1000 nm, such as from 100 to 600 nm, such as from 120 to 450 nm, such as from 150 to 400 nm, such as from 200 to 350 nm. It will be appreciated that each batch of polymer particles will have a very small coefficient of variation between their diameter sizes, as required above.

Each polymeric particle is composed of a network formed by a plurality of polymeric stabilizing components that form a backbone from which a plurality of hydrophobic polymer chains extend from.

Any suitable hydrophilic polymer chain that can be activated at multiple sites by free radical initiators may be used as the polymeric stabilizing components. Examples of suitable hydrophilic polymer chains that may be used herein include, but are not limited to poly(vinylpyrrolidone), polyethylenimine, polyacrylic acid, polyvinyl alcohol, water soluble polysaccharides (e.g. hydroxypropyl methylcellulose, chitosan, and blends thereof), copolymers thereof and blends thereof. In particular examples that may be mentioned herein, the hydrophilic polymer chains of the polymeric stabilizing components may be poly(vinylpyrrolidone).

Without wishing to be bound by theory, it is believed that such hydrophilic polymer chains when activated by free radical initiators each contain multiple radical sites, each of these radical sites can then propagate the formation of a hydrophobic polymer chain upon the introduction of hydrophobic monomers to a reaction mixture. As will be appreciated, a number of these radical sites on separate hydrophilic polymer chains may cross-react together, such that two (or more, such as a plurality) of the hydrophilic polymer chains become directly crosslinked together to form a network of hydrophilic polymer chains, while still retaining other radical sites that can react with hydrophobic monomers to form the hydrophobic polymer chains. In addition, a hydrophobic polymer chain might chain-terminate by reacting with a radical site on a hydrophilic polymer chain, thereby indirectly crosslinking two hydrophilic polymer chains (or a chain and a network or two networks) together.

Any suitable hydrophobic monomer that can undergo a radical chain reaction may be used to form the hydrophobic polymer chains referred to herein. Examples of suitable hydrophobic monomers include styrene and derivatives thereof, acrylates, alkylacrylates and combinations thereof. Examples of styrene and its derivatives include, but are not limited to, styrene, 4-methylstyrene, 3-methylstyrene, and 4-tertbutylstyrene. Examples of acrylates include, but are not limited to, methyl acrylate, ethyl acrylate, propyl acrylate and, more particularly, butyl acrylate. Examples of alkylacrylates include, but are not limited to, 2,2,2-trifluoro ethyl methacrylate and methyl methacrylate. In particular embodiments of the invention that may be mentioned herein, the hydrophobic monomer may be styrene.

Any suitable weight:weight ratio of the polymeric stabilizing components to the plurality hydrophobic polymer chains may be used in the polymer particles disclosed herein. Examples of suitable weight:weight ratio of the polymeric stabilizing components to the plurality hydrophobic polymer chains that may be mentioned herein may be from 1:1000 to 1:1, such as from 1:500 to 1:2, such as from 1:300 to 1:3, such as from 1:150 to 1:5.

As will be appreciated, the base polymer particles may be useful as they are. However, it may be advantageous to incorporate yet further properties into the polymer particles that may open up further potential uses for these monodisperse materials. This may be achieved by forming the hydrophobic polymer chains as copolymers and/or with crosslinkers.

As will be appreciated, the hydrophobic polymer chains described above may already include copolymers formed by two or more hydrophobic monomeric materials. Thus, when used herein, the term “copolymers” may particular refer to the introduction of monomers that will retain pendant reactive functionality following their incorporation into the hydrophobic polymer chain. For example, when the hydrophobic polymer chains are copolymers, they may be formed from:
a first set of monomers that is hydrophobic selected from one or more of styrene and derivatives thereof, acrylates, and alkylacrylates; and
a second set of monomers selected from one or more of monomers having a carboxylic acid group, a monomer having hydroxyl group, a monomer having an amino group, and a monomer having an epoxy group

The first set of monomers are identical to the materials described above as the monomers that may be used to make the hydrophobic polymers chains. As such, the definitions described above also apply here and are not repeated. The second set of monomers are materials that retain pendant reactive functionality (e.g. a free hydroxyl group, a free carboxylic acid and the like) following their incorporation into the hydrophobic polymer chain. Examples of such materials include, but are not limited to, acrylic acid, methacrylic acid, 2-carboxyethyl acrylate, acrylamide, methacrylamide, allylamine, (hydroxyethyl)methacrylate, hydroxypropyl methacrylate, 4-hydroxybutyl acrylate, glycidyl methacrylate, allyl glycidyl ether, 1,2-epoxy-5-hexene, 1,4-diamino-6-diallylamino-1,3,5-triazine, diallylamine, triallylamine and combinations thereof.

As will be appreciated, as the hydrophobic polymer chains are intended to retain at least some hydrophobic character, the first set of monomers will form at least 50%, in for the majority of the hydrophobic polymer chains. For example, the weight:weight ratio of the first set of monomers to the second set of monomers may be from 40:1 to 1:1, such as from 20:1 to 2:1.

It is noted that the introduction of the second set of monomers into the hydrophobic polymer chains introduces functionalities, such as carboxylic acid groups that can be used for further reactions, such as in immunodiagnostic applications. For example, said reactive functionalities may be used to conjugate with antibodies which will react with antigens in the immunodiagnostic test to which it is applied.

When the hydrophobic polymer chains are crosslinked together and suitable crosslinking agent that can react with the first and/or (if present) the second set of monomer may be used. Examples of suitable crosslinking agents include monomeric materials that have two or more unsaturated groups (and so can partake in the radical chain extensions of the hydrophobic polymer chains). Particular examples of crosslinking agents that may be mentioned herein include, but are not limited to divinylbenzene, ethylene glycol dimethylacrylate, bisphenol A dimethacrylate, butanediol dimethacrylate, tricyclodecane dimethanol diacrylate, pentaerythritol triacrylate, tripropylene glycol diacrylate, propoxylated neopentyl diacrylate, pentaerythritol triacrylate, ditrimethylolpropane tetraacrylate, dipentaerythritol pentaacrylate, dipentaerythritol penta/hexa-acrylate, tripropylene diacrylate, trimethylol propane ethoxylate triacrylate, trimethylol propane propoxylate triacrylate, di(trimethylolpropane) tetraacrylate, glycerol propoxylate triacrylate, pentaerythritol propoxylate triacrylate, poly(ethylene glycol) diacrylate, poly(propylene glycol) diacrylate, tri(propylene glycol) diacrylate and combinations thereof.

The hydrophobic polymer chains may incorporate any suitable amount of the crosslinking agent into the resulting crosslinked structure. For example, the weight:weight ratio of the first set of monomers to the second set of monomers may be from 40:1 to 1:1, such as from 20:1 to 2:1. When used herein, the term “first set of monomers” is intended to refer to the hydrophobic monomers that form the entire hydrophobic polymer chains in the absence of any crosslinking agent and/or a second set of monomers that retain a pendant reactive functionality following their incorporation into the hydrophobic polymer chain.

The crosslinking monomers can enhance the solvent tolerance of the polystyrene particles.

In embodiments of the invention disclosed herein, the polymer particles may also be functionalised by a sulfate salt with the formula —SO₄⁻M⁺, where the dash represents the point of attachment to the polymer particles and M⁺ may represent Na⁺, K⁺, or NH₄⁺.

In particular embodiments of the invention that may be mentioned herein, the hydrophobic polymer chains in the polymer particles may be formed from:

styrene alone;

styrene and one or more of N,N′-methylenebis(acrylamide), 1,4-Diamino-6-diallylamino-1,3,5-triazine, diallylamine, and triallylamine as a copolymer;

styrene that is crosslinked by a crosslinking agent selected from one or more of divinylbenzene, ethylene glycol dimethylacrylate, bisphenol A dimethacrylate; or

styrene and one or more of N,N′-methylenebis(acrylamide), 1,4-Diamino-6-diallylamino-1,3,5-triazine, diallylamine, and triallylamine as a copolymer that is crosslinked by a crosslinking agent selected from one or more of divinylbenzene, ethylene glycol dimethylacrylate, bisphenol A dimethacrylate.

Also disclosed herein is a method of generating polymer particles, the method comprising:

(A) reacting a hydrophilic polymeric stabilizer compound with a water-soluble initiator compound in water to form a macroinitiator complex in an aqueous solution;

(B) forming a biphasic polymerisation reaction mixture by adding one or more water-immiscible monomers to the macroinitiator complex in an aqueous solution, and allowing the reaction to run for a first period of time until particle nucleation occurs; and

(C) either allowing the reaction to continue for a second period of time or quenching the reaction after the first period of time to provide the polymer particles, wherein the polymer particles are monodisperse and have a coefficient of variation based on their diameter of less than 20%.

As will be appreciated, full details of the product are discussed above and so are not repeated here for brevity.

When used herein, the term “macroinitiator complex” refers either to single polymer strands of a hydrophilic polymeric stabilizer compound that contains a plurality of radicals along the polymer backbone or to a crosslinked set of two or more polymer strands of a hydrophilic polymeric stabilizer compound (each crosslink formed by radical reaction between polymer strands) that contains a plurality of radicals along the polymer backbones of the two or more crosslinked polymer strands. Said macroinitiator complexes are used to initiate the growth of hydrophobic polymer chains, where a plurality of hydrophobic polymer chains may be formed on the backbone of each macroinitiator complex. As will be appreciated, the macroinitiator complexes are formed by the reaction between the hydrophilic polymer stabilizer compound and the water-soluble initiator compound, which may generate free radicals that abstract hydrogen atoms from the hydrophilic polymer stabilizer compound to generate free radicals along the polymer backbone of said compound.

Any suitable water-soluble initiator may be used herein. Examples of suitable water-soluble initiators include a peroxide initiator, a persulfate salt, an azo initiator and combinations thereof. Particular examples of the water-soluble initiator include, but are not limited to, tertiary-amyl hydroperoxide, potassium persulfate, sodium persulfate, ammonia persulfate, 4,4′-azobis(4-cyanovaleric acid), 2,2′-azobis[2-methyl-N-(2-hydroxyethyl)propionamide, 2,2′-azobis[N-(2-carboxyethyl)-2-methylpropionamidine]hydrate, 2,2′-azobis(2-methylpropionamidine) dihydrochloride, 2,2″-azobis[2-(2-imidazolin-2-yl)propane], 2,2′-azobis[2-(2-imidazolin-2-yl)propane] dihydrochloride and combinations thereof. In particular embodiments that may be mentioned herein, the water-soluble initiator may selected from one or more of potassium persulfate, sodium persulfate, and ammonia persulfate. In yet more particular embodiments that may be mentioned herein, the water-soluble initiator may be sodium persulfate.

Additionally or alternatively, the water-soluble initiator may be a redox pair. Any suitable redox pair may be used herein. For example, the redox pair may be selected from ascorbic acid and hydrogen peroxide or ammonia persulfate and sodium bisulfite.

As will be appreciated, the above-mentioned materials are capable of auto-generating radicals when subjected to the correct conditions to do so. For example, upon heating in an aqueous solution, a persulfate ion undergoes thermal decomposition to provide two sulfate ion radicals (SO₄⁻.) that are able to abstract a hydrogen atom from a polymer molecule and thus generate a radical on the polymer backbone.

Any suitable molar ratio of the water-soluble initiator compound to the hydrophilic polymeric stabilizer compound may be used. For example, the molar ratio of the water-soluble initiator compound to the hydrophilic polymeric stabilizer compound may be from 10:1 to 10,000:1, such as from 20:1 to 5,000:1, such as from 30:1 to 1000:1, such as from 50:1 to 500:1. For the avoidance of doubt, it is explicitly contemplated that where a number of numerical ranges related to the same feature are cited herein, that the end points for each range are intended to be combined in any order to provide further contemplated (and implicitly disclosed) ranges. Thus, in relation to the above related numerical ranges, there is disclosed:

from 10:1 to 20:1, from 10:1 to 30:1, from 10:1 to 50:1, from 10:1 to 500:1, from 10:1 to 1000:1, from 10:1 to 10,000:1;

from 20:1 to 30:1, from 20:1 to 50:1, from 20:1 to 500:1, from 20:1 to 1000:1, from 20:1 to 10,000:1;

from 30:1 to 50:1, from 30:1 to 500:1, from 30:1 to 1000:1, from 30:1 to 10,000:1;

from 50:1 to 500:1, from 50:1 to 1000:1, from 50:1 to 10,000:1;

from 500:1 to 1000:1, from 500:1 to 10,000:1; and

from 1000:1 to 10,000:1.

The hydrophilic polymeric stabilizer compound corresponds to the plurality of polymeric stabilizing components, each polymeric stabilizing component comprising one or more hydrophilic polymer chains. As such, the same polymeric materials mentioned above as hydrophilic polymer chains may be used herein. In particular embodiments that may be mentioned herein, the hydrophilic polymeric stabilizer compound may be poly(vinylpyrrolidone) and/or a water soluble polysaccharide, such as hydroxypropyl methylcellulose.

Any suitable concentration of the hydrophilic polymeric stabilizer compound in the aqueous solution of step (A) may be used. For example, the concentration of the hydrophilic polymeric stabilizer compound in the aqueous solution of step (A) may be from 0.01% to 20 wt %, such as from 0.05% to 10 wt %, such as from 0.1% to 5.0 wt %. The degree of crosslinking in the macroinitiator complex will largely depend on the concentration of hydrophilic polymeric stabilizer compound added to the aqueous solution. The degree of crosslinking in the macroinitiator complex, in turn, affects the diameter of the generated polymer particles, the beads monodispersity, as well as the beads stability. Without wishing to be bound by theory, it is believed that the macroinitiator helps to avoid the aggregation of beads, favouring the formation of highly monodisperse polystyrene beads.

The water-immiscible monomers may be the monomers used to form the hydrophobic polymer chains referred to above in the polymer particle product. As such, the water-immiscible monomers may be selected from one or more of styrene and derivatives thereof, acrylates, and alkylacrylates. Examples of styrene and its derivatives include, but are not limited to, styrene, 4-methylstyrene, 3-methylstyrene, and 4-tertbutylstyrene. Examples of acrylates include, but are not limited to, methyl acrylate, ethyl acrylate, propyl acrylate and, more particularly, butyl acrylate. Examples of alkylacrylates include, but are not limited to, 2,2,2-trifluoro ethyl methacrylate and methyl methacrylate. In particular embodiments of the invention that may be mentioned herein, the water-immiscible monomer may be styrene.

In embodiments of the invention, the weight:weight ratio of the hydrophilic polymeric stabilizer compound to the water-immiscible monomers may be from 1:1000 to 1:1, such as from 1:500 to 1:2, such as from 1:300 to 1:3, such as from 1:150 to 1:5.

The water-immiscible monomer concentration in the reaction mixture of step (B) may be from 0.1 to 40.0 wt %, such as from 1 to 30 wt %, such as from 2-20 wt %. The resulting colloid solution may have a dry mass between 0.1 wt % and 40 wt %, preferably between 1 wt % and 30 wt %, more preferably between 2 wt % and 20 wt % relative to the weight of the solution.

As noted above, the monomeric materials are water-immiscible, which is important to the success of the currently described method. Without wishing to be bound by theory, it is believed that the water-immiscible monomers are constantly dissolving from the oil phase into the aqueous phase to feed the polymerisation process. This results in a low concentration of the water-immiscible monomer in the aqueous phase, which slows the rate of polymerisation and prolongs the nucleation process. The resulting biphasic polymerisation reaction mixture is different to the reaction mixture generated from the conventional homogeneous dispersion polymerisation, where the concentration of monomer in the organic solvent phase is high. The macroinitiator complex, being hydrophilic, also helps to slow down the nucleation process by keeping the polymerisation product in the aqueous phase. Without wishing to be bound by theory, it is believed that the slow and long nucleation process results in the generation of highly monodisperse polymer particles (or beads).

It is noted that after step (B) has completed, no new polymer particles can be nucleated in the rest of the process described below. The period for obtaining nucleation of the particles may be from 15 to 45 minutes.

As noted above, step (C) of the method may result in quenching of the formed particles (providing monodisperse polymer particles of minimal size) or the reaction may be continued. If the reaction is continued without the introduction of new materials (e.g. potential copolymeric materials), then the particles are simply allowed to grow in size to provide polymeric particles that are monodisperse as discussed hereinbefore. Alternatively, if additional functionality is desired, then a second set of monomers and/or or a crosslinking agent is added to the reaction mixture to generate a product where the hydrophobic polymer chains contain polymers having pendant reactive functionality and/or are where the hydrophobic polymer chains are crosslinked together.

When a second set of monomers is added to the reaction mixture in step (C), they may be selected from one or more of monomer having a carboxylic acid group, a monomer having hydroxyl group, a monomer having an amino group, and a monomer having an epoxy group. When a crosslinking agent is added to form crosslinks, the crosslinking agent may be a monomer having two or more unsaturated groups. As such, the second set of monomers and crosslinking agent are identical to those described in detail above with respect to the polymer particle product and will not be described again here for brevity.

When the second set of monomers is added to the reaction mixture, the weight:weight ratio of the first set of monomers (i.e. the water-immiscible monomers) to the second set of monomers is from 40:1 to 1:1, such as from 20:1 to 2:1. When the crosslinker is added to the reaction mixture, the weight:weight ratio of the first set of monomers (i.e. the water-immiscible monomers) to the crosslinking agent is from 40:1 to 1:1, such as from 20:1 to 2:1.

The disclosed method allows the particle size and dispersity of the generated polymer particles to be controlled by the molecular weight and concentration of the macroinitiator complex. The macroinitiator complex is hydrophilic, which retards the nucleation process of polymer particles so that the bigger particle size can be achieved. The resultant polymer beads or particles having a cross-linked structure are stable and free of organic solvents and surfactants.

Advantages of the disclosed method include:

(1) The provision of monodisperse polymer particles having a particle size range or average diameter of from 100 to 370 nm can be achieved. Previous surfactant-free methods were unable to provide beads bigger than 250 nm (particularly for polystyrene beads).

(2) Both monodispersity and size control can be consistently achieved. Previous methods were found to lose monodispersity when bigger particle sizes are achieved.

(3) The current method is a one-pot process that meets the target particle size of an immunodiagnostic assay.

(4) Conventionally, addition of co-monomers or a second set of monomers negatively affects the size and dispersity. In the current method, co-monomers can be added after nucleation without significantly affecting the whole system.

(5) In the current method, the macroinitiator complex plays a duo-role of a nucleation template and a crosslinking agent.

(6) The use of a hydrophilic macroinitiator complex prevents secondary nucleation, leading to highly monodisperse beads.

(7) The current method may allow direct use of commercial monomers without purification (e.g. treatment by NaOH) to remove stabilizer (4-tert-butylcatechol).

Further aspects and embodiments of the invention are provided in the following non-limiting examples.

### EXAMPLES

The current invention relates to a highly monodisperse polymer particles or polymer beads afforded by a novel “monomer-deficient polymerisation initiation and nucleation” strategy, which is different from conventional dispersion polymerisation, emulsion polymerisation and surfactant-free emulsion polymerisation.

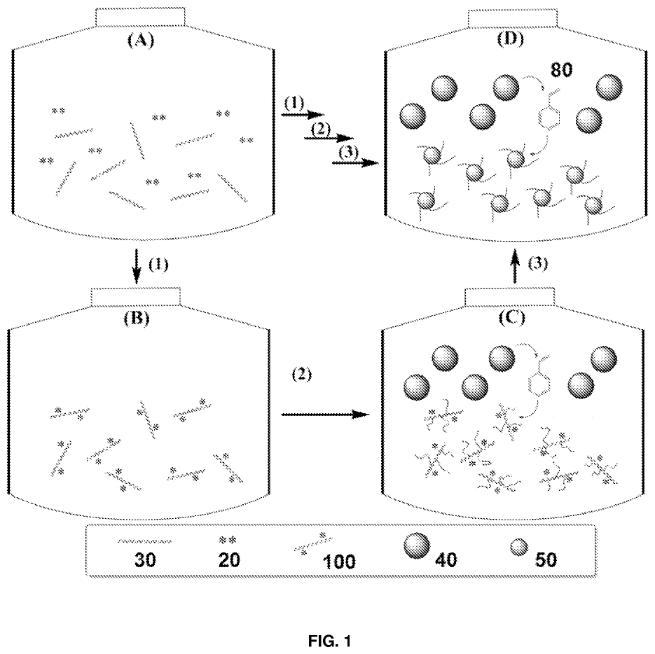

In an embodiment of the invention, highly monodisperse polystyrene particles (or polystyrene beads) having a particle size of from 100 to 370 nm are prepared via a one-pot synthesis involving water as the sole solvent, styrene monomers 40, and a hydrophilic macroradical 100 formed by mixing a water-soluble initiator 20 and hydrophilic polymer stabilizer 30, as depicted in the schematic representation of FIG. 1.
In Step 1, a homogeneous water solution (B) comprising a hydrophilic macroradical 100 (or macroinitiator complex) is first formed by adding a water-soluble initiator 20 (e.g. a persulfate initiator) and a hydrophilic polymer stabilizer 30 (e.g. a PVP stabilizer) into water, and subsequently heating the solution (A) such as to activate the initiator and generate new free radicals on the hydrophilic polymer stabilizer 30 via hydrogen abstraction.
In Step 2, styrene monomers 40 are then added to (B) to form a bi-phasic system (C) comprising an oil phase and an aqueous phase, where the oil phase is substantially formed from styrene monomers 40.
As styrene monomers 40 slowly dissolve as droplets 80 in the aqueous phase, polymerisation of styrene monomers 40 is initiated by the hydrophilic macroradical 100, resulting in polystyrene 50 precipitation and nucleation in the aqueous phase of the bi-phasic system (D) (step 3).
Optionally, after nucleation of polystyrene 50 is completed, co-monomers can be added (not depicted in FIG. 1).

Step 1

Typically in step 1, the hydrophilic polymer stabilizer and water-soluble initiator are fully dissolved in water at room temperature to form a homogeneous mixture (A). The system is then heated to above the thermal decomposition of the initiator. The thermal decomposition temperature is typically between 40-100° C. (eg. 60-90° C.). The thermal decomposition of initiator leads to formation of free radicals. The water-soluble initiator can be chosen from peroxide initiators, persulfate salts and azo initiators. For example, persulfate initiators thermally decompose to yield two species, the sulphate ion radical (SO₄.⁻) and the hydroxyl (.OH) radical, which are capable of abstracting a hydrogen atom from the polymer molecule to form a hydrophilic macroradical. In an embodiment of the invention, sodium persulfate (SPS) is used as an initiator, which is cheaper than KPS, APS and AIBA. It is believed that this is the first reported use of SPS in surfactant-free polymerisation of styrene.

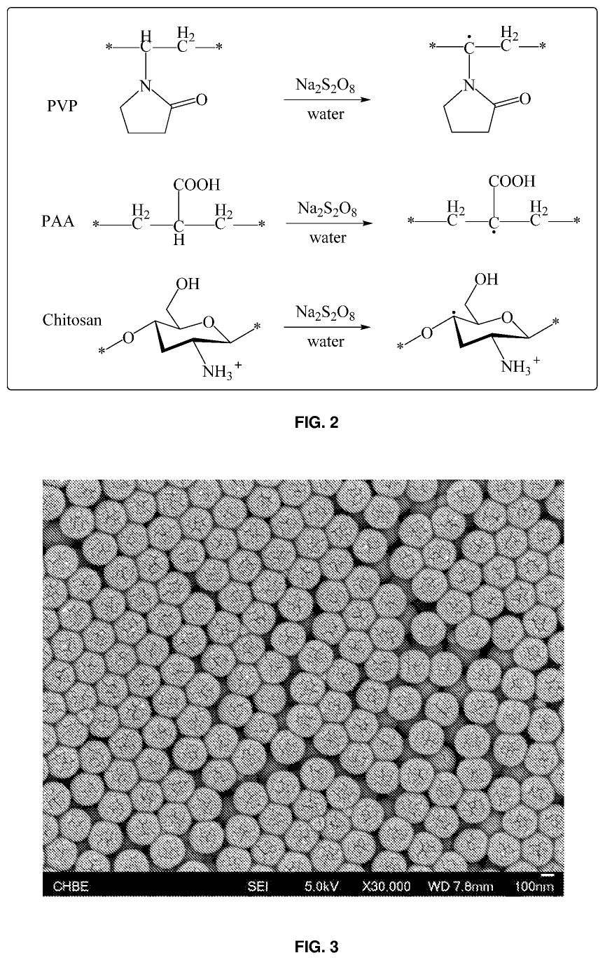

Generally, a free radical site is formed by abstracting a hydrogen atom from an alpha carbon of the hydrophilic polymer stabilizer. The mechanism of H-abstraction for selected hydrophilic polymer stabilizers is depicted in FIG. 2. H-abstraction occurs on the vinyl group of PVP to form a macroradical, which may rearrange to a more stable state by chain scission via disproportionation, in the neighbourhood of the unpaired electron. By a similar process, H-abstraction occurs on the vinyl group of PAA. Radical formation on chitosan is due to the anionic radical attack on the C-4 carbon, which transfers the radical to the C-4 carbon with the removal of hydrogen from it.

Step 2

Typically, the monomer as used in Step 2 should have limited solubility in water (or water-immiscible) in order to form a bi-phasic system (C). For example, the solubility of styrene in water is 0.030 g styrene/100 g solution at 25° C. (JACS 1950, 72, 5034-5037) and 0.058 g/100 g solution at 65° C. (Ind. Eng. Chem. Anal. Ed. 1946, 18, 295-296). As styrene is slowly dissolved into the aqueous phase, styrene will be grafted on the macroradical formed from step 1, triggering the continuous dissolution and polymerisation of styrene.

Step 3

Typically in step 3, polymer precipitation and nucleation process take place in the aqueous phase. For example, the conjugation of PVP with branched styrene oligomers results in a decreased solubility in water. As the polystyrene chain grows longer, the polymer starts to form nuclei in the aqueous phase. The polystyrene precipitation and nucleation process is similar to homogeneous dispersion polymerisation, but differs in that they occur in a bi-phasic system.

The monodispersity of the polymerisation product appears to be due to the poor solubility of styrene monomers in the aqueous phase. Styrene is constantly dissolving into the aqueous phrase from the oil phase to feed the polymerisation process and grow the polystyrene beads. This results in a low concentration of styrene in the aqueous phase, especially at the beginning of the polymerization, which slows the rate of polymerisation and prolongs the nucleation process (˜30 min). In contrast, the nucleation process of a homogeneous dispersion polymerisation is much faster (˜10 min.) due to high styrene concentration. The hydrophilic macroradical also helps to slow down the nucleation process by keeping the polymerisation product in the aqueous phase for a longer time before polystyrene precipitation starts. Without wishing to be bound by theory, it is believed that the slow and long nucleation process results in formation of highly monodisperse polystyrene beads.

After nucleation starts, the polystyrene particles become swollen and concentrated with styrene monomers, which can accelerate the rate of polymerisation. This allows the polystyrene bead to be more spherical and to render the beads with a smooth surface. As a result, the particles grow bigger and denser. The polymerization ends when all the styrene monomers are used up and incorporated in the monodisperse polystyrene beads.

Optionally, a co-monomer can be added to the polystyrene beads (or after nucleation is completed) to improve the stiffness of the particle (or beads) or to functionalise the surface (by adding a co-monomer bearing a functional group).

Materials and Methods

The materials were purchased from the sources as provided below.

Styrene (Tokyo Chemical Industry Co. Ltd. (TCI), stabilised with 4-tert-butylcatechol, >99.0% (GC)),

Sodium persulfate (Na₂S₂O₈, SPS; Alfa Aesar, crystalline, 98%),

Polyvinylpyrrolidone (PVP; K30, MW=45000-58000; K60, MW=270,000-400,000; K90, MW=1,000,000-1,500,000; TCI, total nitrogen 12.0% to 12.8% (calculated on anhydrous substance); water max. 7.0%, K value 26.0 to 34.0),

Sodium chloride (NaCl; Alfa Aesar, ACS, 99.0% min),

Acrylic acid (TCI; >99.0% (GC)),

Divinylbenzene (DVB; Sigma-Aldrich, 85%).

Deionised (DI) water was obtained from ELGA Ultrapure Water Treatment Systems (PURELAB Option).

Hydrochloric acid, Sigma-Aldrich, 37%.

Sodium hydroxide, BioXtra, ≥98% (acidimetric), pellets (anhydrous).

SEM imaging was performed using a JEOL JSM 6700F according to the procedure set out in Cryst Eng Comm, 2017, 19, 552-561. References to “average” diameters refer to the average diameter obtained from SEM.

Mechanical stirrer was a Wiggens, WB2000-M overhead stirrer.

Coefficient of variation (CV) % of the polystyrene beads was calculated from SEM image measurement. A droplet of the as-synthesised latex solution was placed onto a flat surface (eg. an aluminium foil) and dried overnight at ambient temperature. The resulted samples were mounted onto SEM stubs using conductive double sided carbon tape. The stub with samples was sputter-coated with a thin layer of platinum. The prepared sample was examined with SEM (Model JEOL JSM 6700F). The diameters of 100 randomly selected particles were measured from the images of 30,000 magnification for all the samples and the standard deviation was calculated accordingly.

Mechanical stirring (200 rpm) was used for all polymerisation processes. Prior to use, DI water was bubbled with nitrogen for 20 min to remove oxygen. SPS, PVP, NaCl, acrylic acid, DVB and styrene were used as received without purification.

### Example 1

A 250 mL two-necked round bottom glass reactor equipped with a mechanical stirrer was added with SPS (76 mg), PVP (K60, 1 g), NaCl (584 mg) and DI water (100 mL). The side neck of the reactor was then sealed with a rubber septum and nitrogen was introduced via a needle to sweep the air in the reactor. The mixture was stirred for ˜5 min to obtain a homogeneous solution at room temperature, and then heated in an oil bath at 70° C. for about ˜10 min. The required amount of styrene (10 mL) was quickly injected into the reactor with a syringe. The styrene formed an oil layer on top of the aqueous solution. The resulting mixture slowly became cloudy and after 30 min, turned into a white suspension, indicating that the polymerisation rate and nucleation process was slow. The polymerisation mixture was stirred overnight for 20 hours at 70° C., affording a milky colloidal solution. The as-synthesised colloidal solution was denoted as “sample 1” and the surface morphology of the sample was observed using Scanning Electron Microscopy JEOL JSM-6700.

The SEM image (FIG. 3) shows that the diameter of the obtained polystyrene beads was 260 nm, with CV 1%. No anomalous regions were observed on the polystyrene beads.

This experiment shows that the pre-formed macroradical leads to highly monodisperse polystyrene beads at high ionic strength reaction conditions (as contributed by NaCl).

### Example 2

A 250 mL two-necked round bottom glass reactor equipped with a mechanical stirrer was added with SPS (86 mg), PVP (K30, 200 mg) and DI water (100 mL). The side neck of the reactor was then sealed with a rubber septum and nitrogen was introduced via a needle to sweep the air in the reactor. The mixture was stirred for ˜60 min to obtain a homogeneous solution at room temperature, and then heated in an oil bath at 70° C. for about ˜20 min. The required amount of styrene (30 mL) was quickly injected into the reactor with a syringe. The styrene formed an oil layer on top of the aqueous solution. The resulting mixture slowly became cloudy and after 30 min, turned into a white suspension, indicating that the polymerisation rate and nucleation process was slow. The polymerisation mixture was stirred overnight for 20 hours at 70° C., affording a milky colloidal solution. The as-synthesised colloidal solution was denoted as “sample 2” and the surface morphology of the sample was observed using Scanning Electron Microscopy JOEL JSM-6700.

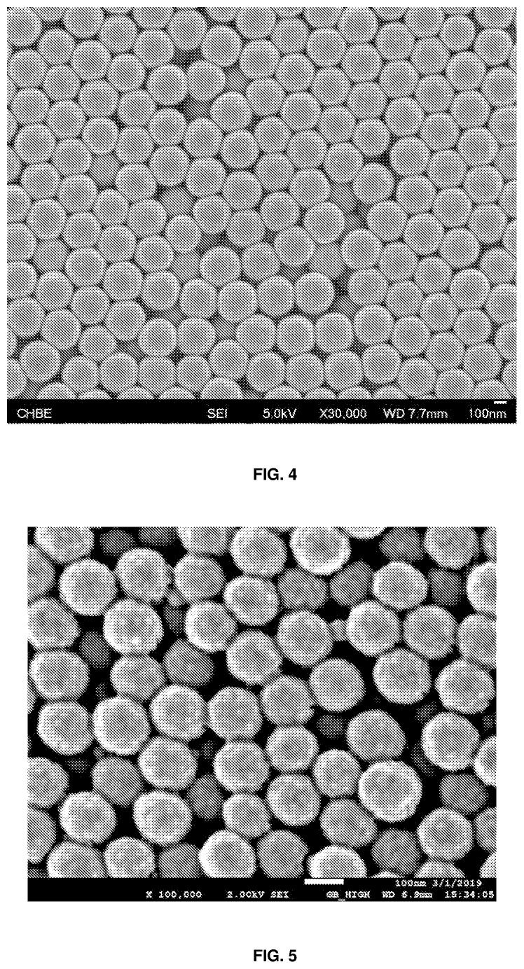

The SEM image (FIG. 4) shows that the diameter of the obtained polystyrene beads was 310 nm, with CV 1%. No anomalous regions were observed on the polystyrene beads.

This experiment shows that the pre-formed macroradical leads to highly monodisperse polystyrene beads at low ionic strength reaction conditions (absence of NaCl).

### Example 3

A 250 mL two-necked round bottom glass reactor equipped with a mechanical stirrer was added with SPS (57 mg), PVP (K90, 1 g), and DI water (100 mL). The side neck of the reactor was then sealed with a rubber septum and nitrogen was introduced via a needle to sweep the air in the reactor. The mixture was stirred for ˜5 min to obtain a homogeneous solution at room temperature, and then heated in an oil bath at 70° C. for about ˜3 min. The required amount of styrene (10 mL) was quickly injected into the reactor with a syringe. The styrene formed an oil layer on top of the aqueous solution. The resulting mixture slowly became cloudy and after 30 min, turned into a white suspension, indicating that the polymerisation rate and nucleation process was slow. The polymerisation mixture was stirred overnight for 20 hours at 70° C., affording a milky colloidal solution. The as-synthesised colloidal solution was denoted as “sample 3” and the surface morphology of the sample was observed using Scanning Electron Microscopy JEOL JSM-6700.

The SEM image (FIG. 5) shows that the diameter of the obtained polystyrene beads was 120 nm, with CV 2%. No anomalous regions were observed on the polystyrene beads.

This experiment shows that the pre-formed macroradical can produce highly monodisperse polystyrene beads with diameter as low as 120 nm using low initiator concentration.

### Example 4

A 250 mL two-necked round bottom glass reactor equipped with a mechanical stirrer was added with SPS (46 mg), PVP (K60, 100 mg) and DI water (100 mL). The side neck of the reactor was then sealed with a rubber septum and nitrogen was introduced via a needle to sweep the air in the reactor. The mixture was stirred for ˜5 min to obtain a homogeneous solution at room temperature, and then heated in an oil bath at 70° C. for about ˜3 min. The required amount of styrene (30 mL) was quickly injected into the reactor with a syringe. The styrene formed an oil layer on top of the aqueous solution. The resulting mixture slowly became cloudy and after 30 min, turned into a white suspension, indicating that the polymerisation rate and nucleation process was slow. The polymerisation mixture was stirred for 10 hours at 70° C., and thereafter acrylic acid (5 wt % relative to styrene) was added and the polymerisation was continued for an additional 20 hours at 70° C., affording a milky colloidal solution. The as-synthesised colloidal solution was denoted as “sample 4” and the surface morphology of the sample was observed using Scanning Electron Microscopy JEOL JSM-6700.

SEM

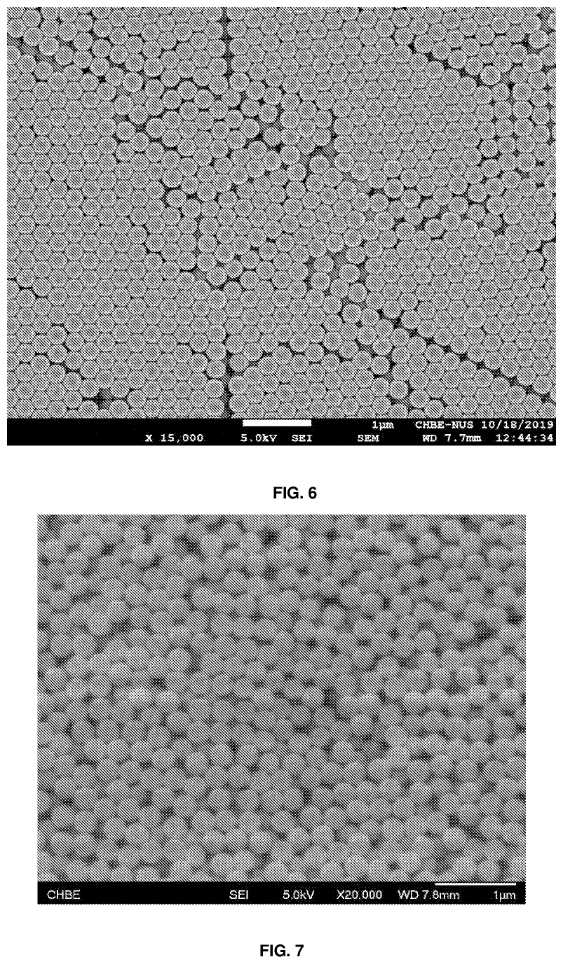

The SEM image (FIG. 6) shows that the diameter of the obtained polystyrene beads was 267 nm, with CV 1%. No anomalous regions were observed on the polystyrene beads.

Acid Titration

The carboxyl groups on the surface of polystyrene particles were measured with a reported method of acid titration (Journal of Colloid and Interlace Science, 1974, 49, 3,425-432). An accurately weighed sample of latex (containing approximately 1 g of polymer solids) was diluted to 25 ml volume with deionized water in a 50 mL container. The pH value of the diluted latex sample was adjusted to 11.0±0.2 by adding a diluted NaOH solution, while pH value was monitored using a pH meter (Hanna Instruments, HI2211). A conductance probe (Hanna Instruments, EC portable meter) was then placed into the diluted latex dispersion. The sample was titrated with standard 0.421 N aqueous HCl under mechanical stirring with 0.050 mL increments and one minute was allowed in between two increments. The conductivity of the latex dispersion was monitored using the EC portable meter. The temperature was maintained at about 25° C. through the titration process.

The titration end point is determined according to literature (Journal of Colloid and Interlace Science, 1974, 49, 3,425-432). The concentration of acid is expressed in terms of milliequivalents charge per gram polymer solids (MEQ/g). The concentration of “surface bound” acid is calculated from the following equation:

$$\frac{M E Q}{g} ( surface bound ) acid = \frac{Vsb \times N}{W \times S}$$

Where Vsb is the volume of HCl titrant in cc required to neutralize the “surface bound” acid; N is the normality of the HCl titrant; W is the sample weight of the latex; and S is the fraction of polymer solids in the latex.

This experiment shows that the surface bound acid density is 0.22 mmol/g, which indicates that monodisperse beads with abundant carboxylic groups can be achieved using the current method. A co-monomer (such as acrylic acid) can be added after the nucleation of polystyrene is completed to achieve surface functionalization with carboxylic acid groups.

### Example 5

A 250 mL two-necked round bottom glass reactor equipped with a mechanical stirrer was added with SPS (476 mg), PVP (K60, 50 mg) and DI water (100 mL). The side neck of the reactor was then sealed with a rubber septum and nitrogen was introduced via a needle to sweep the air in the reactor. The mixture was stirred for ˜5 min to obtain a homogeneous solution at room temperature, and then heated in an oil bath at 70° C. for about ˜3 min. The required amount of styrene (20 mL) was quickly injected into the reactor with a syringe. The styrene formed an oil layer on top of the aqueous solution. The resulting mixture slowly became cloudy and after 30 min, turned into a white suspension, indicating that the polymerisation rate and nucleation process was slow. The polymerisation mixture was stirred overnight for 20 hours at 70° C., and thereafter the reaction system was diluted with DI water (50 mL), followed by the addition of DVB (3.6 g). The polymerisation was continued for an additional 20 hours at 70° C., affording a milky colloidal solution. The as-synthesised colloidal solution was denoted as “sample 5” and the surface morphology of the sample was observed using Scanning Electron Microscopy JEOL JSM-6700.

The SEM image (FIG. 7) shows that the diameter of the obtained polystyrene beads was 250 nm, with CV 1%. No anomalous regions were observed on the polystyrene beads.

This experiment shows that, using pre-formed macroradical, a cross-linker (such as DVB) can be added after the nucleation of polystyrene is completed, producing monodisperse beads with enhanced solvent tolerance.

### Example 6

### Solvent Tolerance Test

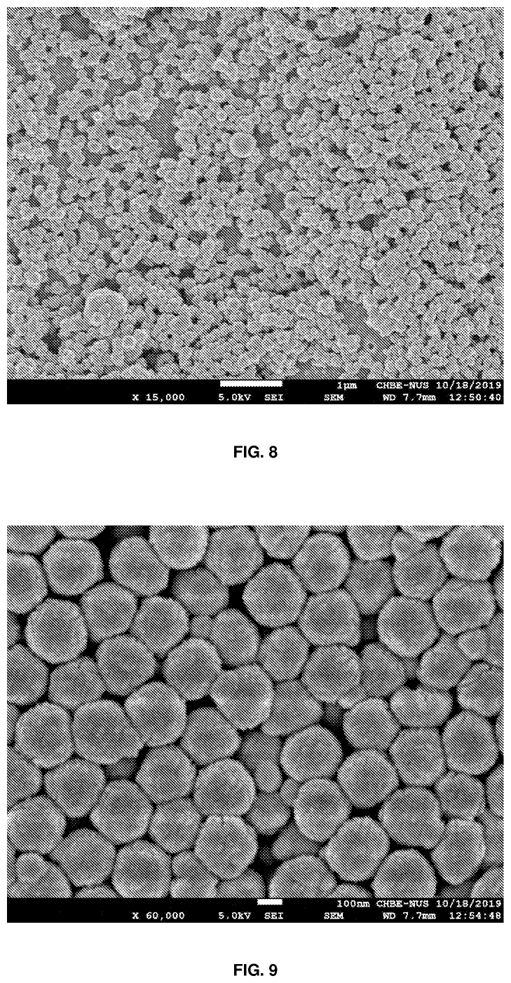

The as-synthesised latex solutions of sample 1 and sample 5 were subjected to a solvent tolerance test. Both samples were mixed with equivalent volume of THF and incubated for 1 hour. SEM images were taken for sample 1 (FIG. 8) and sample 5 (FIG. 9) after incubation. Without crosslinker, the beads were destroyed quickly by THF. However, with 20% of DVB (w/w, DVB to Styrene), the solvent tolerance of polystyrene particles was enhanced.

### Comparative Example 1

A 250 mL two-necked round bottom glass reactor equipped with a mechanical stirrer was added with SPS (46 mg) and DI water (100 mL). The side neck of the reactor was then sealed with a rubber septum and nitrogen was introduced via a needle to sweep the air in the reactor. The mixture was stirred for ˜10 min to obtain a homogeneous solution at room temperature. The required amount of styrene (20 mL) was quickly injected into the reactor with a syringe and the resulting mixture was heated in an oil bath at 70° C. The styrene formed an oil layer on top of the aqueous solution. The resulting mixture slowly became cloudy and after 10 min, turned into a white suspension, indicating that the polymerisation rate and nucleation process was faster as compared with experiments that contain a hydrophilic polymer stabilizer (e.g. PVP). The polymerisation mixture was stirred overnight for 20 hours at 70° C., resulting in a milky colloidal solution. The as-synthesised colloidal solution was denoted as “sample 6” and the surface morphology of the sample was observed using Scanning Electron Microscopy JEOL JSM-6700.

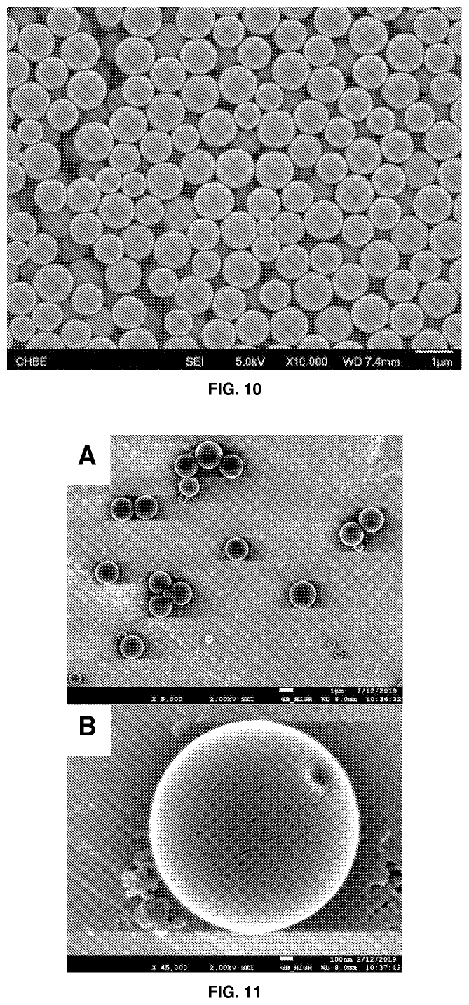

The SEM image (FIG. 10) shows that the obtained polystyrene beads were polydisperse.

This comparative example shows that, without using a pre-formed macroradical, monodisperse polystyrene beads could not be produced, even with a monomer-deficient polymerisation procedure.

### Comparative Example 2

A 250 mL two-necked round bottom glass reactor equipped with a mechanical stirrer was added with DI water (100 mL). The side neck of the reactor was then sealed with a rubber septum and nitrogen was introduced via a needle to sweep the air in the reactor. The required amount of styrene (20 mL) was injected into the reactor with a syringe, followed by constant stirring for 10 min to make a styrene saturated aqueous system, which was heated in an oil bath at 70° C. for about ˜3 min. Then SPS (46 mg) dissolved in 10 mL DI water was injected into the system to initiate the polymerisation. The polymerisation mixture was stirred overnight for 20 hours at 70° C., forming a milky colloidal solution. The as-synthesised colloidal solution was denoted as “sample 7” and the surface morphology of the sample was observed using Scanning Electron Microscopy JEOL JSM-6700.

The SEM image (FIG. 11A) shows that the obtained polystyrene beads were polydisperse. The SEM image (FIG. 11B) shows that the polystyrene beads contained an anomalous region on the surface.

This comparative example shows that, without using a pre-formed macroradical, monodisperse polystyrene beads could not be produced. Because the polymerisation was initiated at styrene-saturated condition, anomalous regions on beads were observed (FIG. 11B), which is believed to be caused by the uneven monomer distribution within the polystyrene particles.

1. A plurality of polymer particles comprising:
a plurality of polymeric stabilizing components, each polymeric stabilizing component comprising one or more hydrophilic polymer chains; and
a plurality of hydrophobic polymer chains, each hydrophobic polymer chain covalently bonded to one or more of the polymeric stabilizing components, wherein:
the plurality of polymer particles are monodisperse and have a coefficient of variation based on their diameter of less than 20%.

2. The plurality of polymer particles according to claim 1, wherein the particles have a coefficient of variation based on their diameter of less than 15%.

3. (canceled)

4. The plurality of polymer particles according to claim 3, wherein the particles have a coefficient of variation based on their diameter of less than or equal to 1%.

5. The plurality of polymer particles according to claim 1, wherein the plurality of polymer particles have an average diameter of from 50 to 1000 nm.

6. The plurality of polymer particles according to claim 1, wherein one or both of the following apply:
(a) the hydrophilic polymer chains of the polymeric stabilizing components are selected from the group consisting of poly(vinylpyrrolidone), polyethylenimine, polyacrylic acid, polyvinyl alcohol, water soluble polysaccharides, copolymers thereof and blends thereof; and
(b) the hydrophobic polymer chains are formed from monomers comprising one or more of styrene and derivatives thereof, acrylates, and alkylacrylates.

7. (canceled)

8.(canceled)

9. (canceled)

10. (canceled)

11. The plurality of polymer particles according to claim 1, wherein a weight:weight ratio of the plurality of polymeric stabilizing components to the plurality of hydrophobic polymer chains is from 1:1000 to 1:1.

12. The plurality of polymer particles according to claim 1, wherein the plurality of hydrophobic polymer chains are formed as copolymers and/or are crosslinked.

13. The plurality of polymer particles according to claim 12, wherein:
(a) when the plurality of hydrophobic polymer chains are copolymers, they are formed from a first set of monomers that is hydrophobic is one or more of styrene and derivatives thereof, acrylates, and alkylacrylates; and
a second set of monomers is one or more of monomers having a carboxylic acid group, a monomer having hydroxyl group, a monomer having an amino group, and a monomer having an epoxy group; and/or
(b) when the plurality of hydrophobic polymer chains are crosslinked, the crosslinked polymer chains are formed by a crosslinking agent that reacts with the first and/or, when present, second set of monomers, optionally wherein the crosslinking agent is a monomer having two or more unsaturated groups.

14. The plurality of polymer particles according to claim 13, wherein:
(ai) the first set of monomers is one or more of styrene, butyl acrylate, 2,2,2-trifluoro ethyl methacrylate, methyl methacrylate, 4-methylstyrene, 3-methylstyrene, and 4-tertbutylstyrene; and/or
(bi) the second set of monomers is one or more of acrylic acid, methacrylic acid, 2-carboxyethyl acrylate, acrylamide, methacrylamide, allylamine, (hydroxyethyl)methacrylate, hydroxypropyl methacrylate, 4-hydroxybutyl acrylate, glycidyl methacrylate, allyl glycidyl ether, 1,2-epoxy-5-hexene, 1,4-diamino-6-diallylamino-1,3,5-triazine, diallylamine, and triallylamine; and/or
(ci) the crosslinking agent is one or more of divinylbenzene, ethylene glycol dimethylacrylate, bisphenol A dimethacrylate, butanediol dimethacrylate, tricyclodecane dimethanol diacrylate, pentaerythritol triacrylate, tripropylene glycol diacrylate, propoxylated neopentyl diacrylate, pentaerythritol triacrylate, ditrimethylolpropane tetraacrylate, dipentaerythritol pentaacrylate, dipentaerythritol penta/hexa-acrylate, tripropylene diacrylate, trimethylol propane ethoxylate triacrylate, trimethylol propane propoxylate triacrylate, di(trimethylolpropane) tetraacrylate, glycerol propoxylate triacrylate, pentaerythritol propoxylate triacrylate, poly(ethylene glycol) diacrylate, poly(propylene glycol) diacrylate, and tri(propylene glycol) diacrylate.

15. (canceled)

16. The plurality of polymer particles according to claim 13, wherein:
(aiii) when present, the weight:weight ratio of the first set of monomers to the second set of monomers is from 40:1 to 1:1; and/or
(biii) when present, the weight:weight ratio of the first set of monomers to the crosslinking agent is from 40:1 to 1:1.

17. (canceled)

18. A method of generating polymer particles, the method comprising:
(A) reacting a hydrophilic polymeric stabilizer compound with a water-soluble initiator compound in water to form a macroinitiator complex in an aqueous solution;
(B) forming a biphasic polymerisation reaction mixture by adding one or more water-immiscible monomers to the macroinitiator complex in an aqueous solution, and allowing the reaction to run until particle nucleation occurs; and
(C) either allowing the reaction to continue for a second period of time or quenching the reaction after the first period of time to provide the polymer particles, wherein the polymer particles are monodisperse and have a coefficient of variation based on their diameter of less than 20%.

19. (canceled)

20. (canceled)

21. The process according to claim 20, wherein the particles have a coefficient of variation based on their diameter of less than or equal to 1%.

22. (canceled)

23. The process according to claim 18, wherein the water-soluble initiator comprises one or more of a peroxide initiator, a persulfate salt and an azo initiator.

24. The process according to claim 23, wherein the water-soluble initiator is one or more of tertiary-amyl hydroperoxide, potassium persulfate, sodium persulfate, ammonia persulfate, 4,4′-azobis(4-cyanovaleric acid), 2,2′-azobis[2-methyl-N-(2-hydroxyethyl)propionamide, 2,2′-azobis[N-(2-carboxyethyl)-2-methylpropionamidine]hydrate, 2,2′-azobis(2-methylpropionamidine) dihydrochloride, 2,2″-azobis[2-(2-imidazolin-2-yl)propane], and 2,2′-azobis[2-(2-imidazolin-2-yl)propane] dihydrochloride.

25. (canceled)

26. (canceled)

27. The process according to claim 23, wherein the water-soluble initiator is a redox pair, optionally wherein the redox pair comprises ascorbic acid and hydrogen peroxide or ammonia persulfate and sodium bisulfite.

28. The process according to claim 18, wherein the hydrophilic polymeric stabilizer compound is selected from the group consisting of poly(vinylpyrrolidone), polyethylenimine, polyacrylic acid, polyvinyl alcohol, water soluble polysaccharides, copolymers thereof and blends thereof.

29. (canceled)

30. (canceled)

31. The process according to claim 18 wherein the one or more water-immiscible monomers are one or more of styrene and derivatives thereof, acrylates, and alkylacrylates.

32. (canceled)

33. (canceled)

34. The process according to claim 18, wherein a weight:weight ratio of the hydrophilic polymeric stabilizer compound to the water-immiscible monomers is from 1:1000 to 1:1.

35. (canceled)

36. The process according to claim 35, wherein a second set of monomers and/or or a crosslinking agent is added to the reaction mixture,
which second set of monomers is one or more of a monomer having a carboxylic acid group, a monomer having hydroxyl group, a monomer having an amino group, and a monomer having an epoxy group,
which crosslinking agent is a monomer having two or more unsaturated groups.

37. (canceled)

38. (canceled)

39. (canceled)

40. (canceled)

41. (canceled)

42. The process according to claim 18, wherein the process is substantively free of surfactants and organic solvents.
